(19) United States
(12) Patent Application Publication
(10) Pub. No.: US 2013/0191183 A1
(43) Pub. Date: Jul. 25, 2013

(54) Information Sharing System for On-Line Real-Time, Localized Cost Comparison for Services

(71) Applicants: Beverley Kite, Los Angeles, CA (US); Connie Santilli, El Granada, CA (US)

(72) Inventors: Beverley Kite, Los Angeles, CA (US); Connie Santilli, El Granada, CA (US)

(21) Appl. No.: 13/749,413

(22) Filed: Jan. 24, 2013

Related U.S. Application Data
(60) Provisional application No. 61/590,461, filed on Jan. 25, 2012.

(51) Int. Cl. G06Q 30/02

(52) U.S. Cl. CPC G06Q 30/0201
USPC 705/7.34; 705/7.29

(57) ABSTRACT

A computer implemented method for providing a user with a cost comparison for neighborhood services comprising creating a database of categories of neighborhood services, the categories created by a system administrator and by users submitting categories, users also submitting prices they have actually paid for neighborhood services and the computer providing to users the prices actually paid by other users and an average of prices actually paid.

### CROSS-REFERENCE TO RELATED APPLICATIONS

This application claims the benefit of provisional application No. 61/590,461 filed Jan. 25, 2012.

### FIELD OF THE INVENTION

The invention relates to a system and method for providing cost comparison for neighborhood services, based on a pool of data generated by the system and updated by submissions from other users of the system, including but not limited to, vendors and potential consumers of services.

### BACKGROUND OF THE INVENTION

There are a number of purchasing decisions that involve services where a product is not exchanged in the purchase. Examples of these types of purchasing decisions include child care related services and household services such as carpet cleaning, tree trimming and gutter cleaning. Other examples include (but are not limited to) professional services, medical services and dental services.

When consumers decide they need to purchase these types of services, the quality of a particular vendor is very important. However, in many cases the cost of a service will be a key factor in making a purchasing decision. In some cases, a consumer will decide whether or not they will proceed with a project based on a general idea of the cost. For example, they may decide to put off hiring a gardener and do the work themselves if they know that the cost of a gardener is not within their budget.

Traditionally, finding information on the cost of these types of services has been difficult. A consumer can find vendors through a directory or review service (either online or offline) and call the vendors to request an estimate. Alternatively the consumer can research online or offline for nationwide estimates of the average cost, usually only available for prior years.

Very often a consumer will ask around for referrals from friends and neighbors. These conversations usually start with the question, “Who are you using?” and end with the question, “How much are you paying?”

These methods will provide the consumer with a general or specific cost, however this is inadequate. Attempting to estimate the cost of a service through contacting multiple vendors or asking around is time-consuming. Unless every vendor is contacted, the data is incomplete and the process robs the consumer of the ability to negotiate a price with knowledge of whether an estimate is too high in their particular market.

A consumer will probably also turn to an online resource in order to get an estimate of cost. Current resources to find this information include question and answer sites, editorial sites or bulletin boards. There are a number of downsides to using these resources. The data is not stored in a structured form, and therefore analytics and statistics are not available. Secondly, these resources do not provide a user with a current estimate and the data is usually nationwide. The cost of services varies greatly between states, rural and urban locations and in the case of large metropolitan cities, between zip-codes. An example of this is the premium placed on the cost of certain services in neighborhoods such as Beverly Hills. The same services may be significantly cheaper a few miles away.

Lastly, for most services, costs change every year or even more frequently. For example, preschool facilities are impacted by the cost of health insurance and liability insurance (among other costs), and these cost increases are passed on to the consumer. Therefore an average cost from several years ago may not be accurate today.

Most estimates for services are based on a number of factors that change the estimate. For example, preschools charge a different amount for part-time programs and full-time programs; gardeners charge a different amount based on the square footage of a yard and window cleaners charge differently based on the number of windows and the number of stories. Nationwide averages usually take into account some of these factors, however they leave it to the consumer to calculate what would be a fair estimate in their particular circumstance or location.

The cost advertised by a particular organization is not always the cost paid by a consumer. Discounts and special offers may reduce the cost actually paid. Differences in implementation of a service may significantly alter the cost. For example, a company may advertise a special offer for carpet cleaning at $99, but differences in the number of carpets or number of rooms may make that special offer non-applicable for certain consumers.

Vendors also have an interest in providing pricelists to consumers and analyzing the prices consumers are paying for a particular service in their neighborhood. For example, a window cleaner may want to indicate the current cost of their services in a neighborhood to consumers who are looking for this particular service. They may also want to analyze what users say they are paying for that same service is the same neighborhood.

Online services review and rank vendors based on the quality of experience. Generally, cost is a non-specific element, for example low, medium or high. Vendor specific websites may have menus of services, but a user would need to trawl through many sites to understand a fair estimate for their neighborhood.

In the end, the consumer and the vendor are the best resources for an accurate estimate of what a consumer would pay for a particular service in their neighborhood if they wanted to purchase that service today.

### SUMMARY

The invention answers the question of what a consumer would pay for a service in a particular neighborhood by combining research performed by administrators of the invention with data shared by users and information submitted by vendors. The invention provides the user with instantaneous feedback on whether they are paying too much or have a good price for a particular service.

The invention is a process where a user can submit what they paid for a particular service (“category”) to the system and can receive immediate feedback from the system as to whether they paid too much, too little or the same as what most people paid in the same neighborhood, for the same category. The system is intended to mimic a social conversation, “What they pay, what you pay”. Submissions can be sent from a mobile device or over the web. Despite the simplification of the interface for the mobile application, it works in the same way as the web application, and uses the same pool of data. The system also provides Application Programmer Interfaces (APIs) and widgets to receive submissions of cost information from other websites and mobile applications, and allow them to display the system information.

One of the significant advantages of the invention is its ability to track costs and present back cost information at the local level, not at the national level. Therefore the invention will always provide local information if that information is available and only show national information if the local information is not available.

Categories are limited to services, goods are not included in the invention and the system is not intended to be a comparison of physical good prices. Category examples include, but are not limited to, preschool, chimney sweeps, gardeners, house keepers, haircuts, tax preparation and home insurance. Examples of categories that would NOT appear in the system include physical items, such as jackets, Starbucks coffee, electronics, etc.

A submitted cost is added to the pool of costs submitted by other users, and used in later comparisons by other users. The minimum, maximum, mode, record count and average paid for the category are recalculated when new cost information is added, to reflect the amount of the new cost information. The mode is equivalent to the most often paid amount for a particular category, i.e the specific amount that has been entered most often for a service. For example, if five users enter what they paid for window cleaning, and three of the users enter $75, one user enters $100 and one user enters $25, the mode/most often paid will be $75. In this situation the average is $70.

The system compares the cost against what other users have paid for the same category in the same zip code/neighborhood or, if no data is available, within a configurable number of miles from the original zip code. If no comparison data is available within the configurable number of miles, nationwide comparisons are utilized,

The system responds with information as to whether the user has paid more, the same or less than what most people paid and the average that people pay for the same category. As most costs are affected by selections made by the user when purchasing the service, the system allows the user to specify these selections in fields. An example of a field for a particular category is the type of program a user has signed up for on a preschool (e.g. either part time, fall time or extended hours). Fields can either be used in the comparison or be stored for informational purposes only. Fields used for informational purposes only, for example the color of the trim on your windows, will not be used in the comparison.

If a user is required to enter a field value for a particular category, the system will display information on whether the user has paid more, the same or less than what people paid who entered the same values; for example, it will be compared against full time preschool entries for users who submitted costs for full time preschool.

If there is information for the zip code the user entered, or information is available within a configurable radius of the zip code the user entered, the system responds with a comparison against this local information. If information is not available within the radius of the zipcode, the national information is displayed. One version will allow the user to select the radius they want to compare against and ask them whether they want to compare at the city, state or nationwide or global level. (The invention is a global application that focuses on local information).

In addition to the cost information, the user can optionally submit the vendor information and a basic ranking of the quality of service. The system will use this information, combined with vendor submitted information (described below) to develop scorecards for a vendor.

For some categories, a video description or picture may be uploaded.

The system is intended to provide the user with an estimate of what they would pay for a given service. In addition, the system will show the user the trends for the cost of a service (i.e. whether the cost has increased or decreased over a particular time period).

To encourage users to submit information, users who submit costs can be awarded points, and can be submitted to prize drawings. To also encourage users to submit, users will be ranked in a chart of most active users based on the points they have been awarded, that is displayed on the home page. The user submissions will also contain an indication of the level of activity for a particular user.

A user is often searching for the cost of a particular category because they plan to pay for that category, and have not yet paid. Therefore the system allows the user to enter their budget for a particular category, or what they have been quoted. These entries are not used in the comparison performed by the system, but are presented to users searching for information at a later date.

If a user cannot find a particular cost category within the system, the user can notify the system that they would like a category to be added to the system. The category enters an administrative process within the system and is approved or not approved by an administrative user. The administrative user will configure the category to ensure it contains the correct information and makes the category active so that other users can view it.

In addition to user submitted cost information, the system will provide vendors with an interface to enter a price list for their services. For example, a window cleaner could submit the cost per story and number of windows and the areas they work in. This information will be presented in the form of a vendor scorecard with the user submitted information in order to provide an estimate to the user. A vendor scorecard will show the pricelist for the vendor services, a rating by users, if one is available, and a report showing whether the vendor's prices are going up or down. Additional vendor information may be available at a later date.

The vendor can also submit discount coupons and advertisements for a specific category and/or location, which will be presented to the user as they view a category. Vendors will be provided with trending and analysis of costs that have been entered by a user for their category in their area.

Other sources of information may be integrated into the system to provide cost information, such as bank Application Programmer Interfaces (API), credit card information, etc.

Categories are configured through an administration interface. Fields can be added to the category that may be entered by the user to provide details that may or may not affect the cost. Examples of fields that affect the cost include: the number of windows for a Window Cleaning Service, or number of rooms for Interior Painting. Examples of fields that do not affect the cost include the subject taught by a Tutor. Fields can be assigned to multiple categories, and can be mandatory or optional. If there are additional fields for the category that should be used in the comparison, the system finds the cost statistics that also match those fields. For example, the system will find what people paid for Tree Trimming services for 3 trees in the 90039 zip code.

The system also communicates the minimum and maximum charges that are paid for the category in the neighborhood or nationally. The system will also show the same statistics for neighboring zip codes.

The system provides tips to the user on how they can reduce their costs for a particular category. In addition, it allows the user to share tips with other users for how to reduce costs.

The system is intended to be a platform for cost data in these service categories. In addition to providing user functionality, the system will have a number of widgets that can be used by other websites to display the cost statistics and allow a user to submit what they paid.

### BRIEF DESCRIPTION OF THE DRAWINGS

FIG. 1 is a block diagram depicting the step by step operation of the invention.

### DETAILED DESCRIPTION OF THE INVENTION

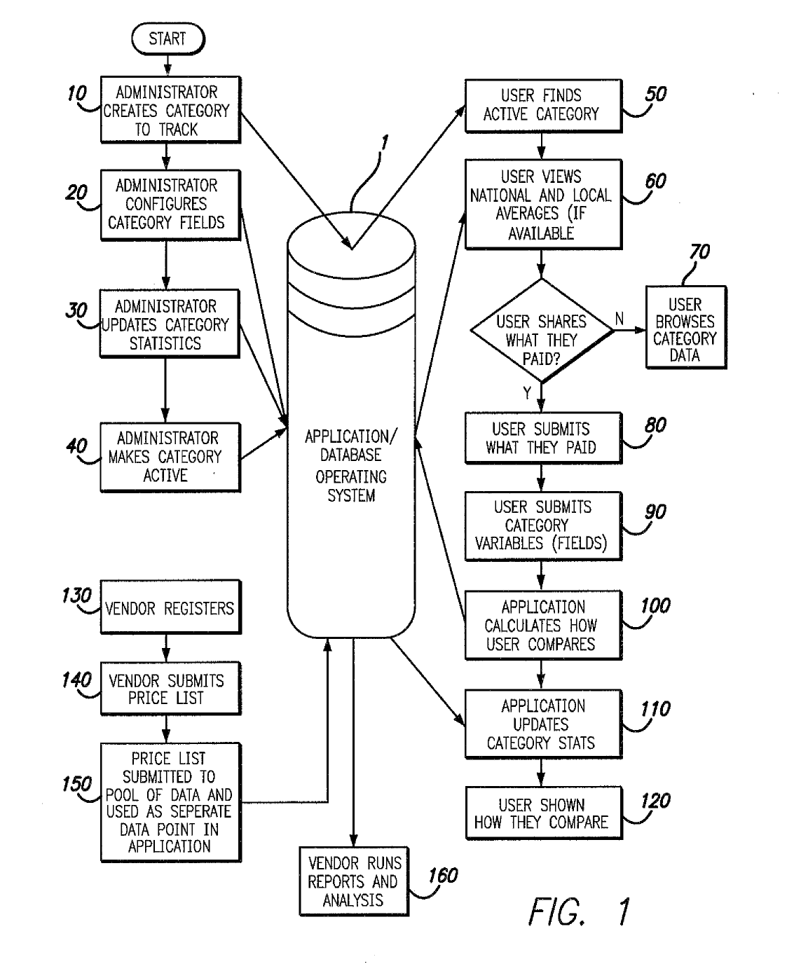

Referring now to FIG. 1, an administrator 10 creates a service category to track by creating key summary data. The administrator 20 configures the specific fields that should be entered for this category, for example, the number of stories for a window cleaner. The administrator configures whether each field should be used for comparison or not. For example, the number of stories will affect cost but whether the window cleaner should whistle while they work will not.

The administrator 30 researches national averages and local information and configures the starting point information for the category. This information will appear as national averages on the summary page for a category. The administrator 40 makes a service category available to users by changing the category from pending to active.

Users 50 find the service category through an external search engine or through an internal application search or application browser. The user 60 opens the category page and views national averages for the category. The user 70 is offered the opportunity to see how they compare against local averages. If they chose not to, they can continue to browse national and local information.

The user 80 submits a quote they have received, their budget for the category, and actual payment made or a plan to pay, for comparison. The user 90 submits category variables (fields) having specific service attributes for comparison.

The system 100 calculates how the user compares to existing data. The user's submission 110 is entered into the pool of available data and will recalibrate the national and local statistics (minimum paid, maximum paid, average and mode/most often paid, as described above.

Then the user 120 is shown how they “stack up” (compare) against the local information. If local information is not available, the national averages for that category are shown (if available). “Stack up” includes, the minimum paid for the category in the local area, the maximum paid for the local area, the average paid for the local area and what has been most often paid (mode).

Vendors can register 130 as users of the system. Once registered, a vendor can submit a price list 140 for a category or selection of categories. The vendor price list is added as an additional data point 150 that will be displayed to the user when they are shown how they compare. The price list information will also be displayed on a vendor scorecard.

Vendors can view detailed analysis and reports 160 on the cost data of a particular category by accessing an interface on the application.

While the present invention has been described in connection with preferred embodiments thereof, those of ordinary skill in the art will recognize that many modifications and variations are possible. The present invention is intended to be limited only by the claims and not by the foregoing description which is intended to set forth

What is claimed is:

1. A computer implemented method for providing a user with a cost comparison for neighborhood services comprising:
creating a database of categories of neighborhood services;
the categories created by a system administrator or by users submitting categories;
users also submitting prices they have actually paid for neighborhood services;
the computer providing to users the prices actually paid by other users and an average of prices actually paid.

2. The method of claim 1 in which the computer implemented method provides to the user the lowest price, the highest price, the average price and the price trend for a neighborhood service.

3. The method of claim 1 in which selected details are added as a field to clarify a particular service.

4. The method of claim 1 in which the computer implemented method utilizes a zip code to designate a neighborhood.

5. The method of claim 4 in which a neighborhood is defined as within a given radius of a zip code.

6. The method of claim 5 in which a user chooses the radius which defines a neighborhood for their search.

7. The method of claim 1 in which a user may select a zip code, city, state, nationwide or global area for their search.

8. The method of claim 1 in which a user may request that a new category be added to the database and an administrator determines whether the new category is added.

9. The method of claim 1 in which a vendor may become a user and enter a price list for their services.

10. The method of claim 9 in which a vendor scorecard is available to users, which comprises the vendor price list, a rating of the vendor by users, and a report showing whether the vendor's pieces are going up, down or remaining the same.

11. The method of claim 9 in which the vendor provides discount coupons to users.

12. The method of claim 1 in which tips to users are provided on how they can reduce their costs for a particular service.

13. The method of claim 1 in which an administrator researches prices and adds the price information to the database.

14. The method of claim 1 in which the most often paid amount for a service is provided to the user.

15. The method of claim 1 in which a user who submits a price that they paid for a service also submits the name of the vendor and a ranking of the quality of the vendor's services.

16. The method of claim 1 in which a user who submits price information to the database receives points toward a benefit or receives entry to a prize drawing.

17. A method for providing a user with a price for a neighborhood service comprising:
a computer having a data base and an operating system;
the database containing prices paid for neighborhood services;
the prices being entered into the database by users of the system, who actually have paid the prices for the neighborhood services;
the computer determining the lowest price paid, the highest price paid, the average price paid and the price most often paid;
the price information being made available to users of the system.

18. The method of claim 17 in which the user may choose a zip code, distance from a zip code, a city, a state, nationwide or global for their search.

19. The method of claim 17 in which a vendor can become a user of the system and enter a price list for services.

20. The method of claim 17 in which the system provides to the user the lowest price, the highest price, the average price and the price trend for a neighborhood service.

21. The method of claim 17 in which application programmer interfaces and widgets receive cost information from other websites and mobile applications and send cost information to other websites and mobile applications.

22. method of claim 1 in which application programmer interfaces and widgets receive cost information from other websites and mobile applications and send cost information to other websites and mobile applications.
